(19) United States
(12) Patent Application Publication
(10) Pub. No.: US 2002/0154060 A1
(43) Pub. Date: Oct. 24, 2002

(54) System and method for providing worldwide seamless location coverage

(75) Inventor: Daniel N. Smith, Prairie Creek, IN (US)

Correspondence Address: Brian M. Berliner, O'MELVENY & MYERS LLP, 400 South Hope Street, Los Angeles, CA, 90071-2899, US

(73) Assignee: AXIOM NAVIGATION, INC.

(21) Appl. No.: 09/837,715

(22) Filed: Apr. 18, 2001

(51) Int. Cl. G01S 1/00

(52) U.S. Cl. 342/385

(57) ABSTRACT

A system and method is provided for transmitting location data to a wireless reception device that cannot otherwise access a satellite navigation system, such as the Global Positioning System (GPS). In the preferred embodiment of the present invention, a wireless location device is adapted to transmit fixed location data. The wireless location device includes a location transceiver, an antenna, and either a battery or a pair of conductive leads adapted to mate with a standard electrical outlet. The wireless location device is fixed to a structure, either by plugging the device into an electrical outlet or with the aid of mounting fixtures, and programmed with fixed location data. Upon receiving a request for location data, the location transceiver encodes the fixed location data within a short-range wireless communication signal, preferably formatted to the Bluetooth protocol. The short-range wireless communication signal is then transmitted through the antenna. In another embodiment of the present invention, a wireless GPS/location device is adapted to transmit location data. The wireless GPS/location device includes a location transceiver, a GPS receiver, two antennas (i.e., first and second), and a power supply. Upon receiving a request for location data through the first antenna, the GPS receiver uses satellite signals received through the second antenna to generate location data, which is then encoded within a short-range wireless communication signal, preferably formatted to the Bluetooth protocol. The short-range wireless communication signal is then transmitted through the first antenna.

### BACKGROUND OF THE INVENTION

1. Field of the Invention

The present invention relates to providing location data to a wireless reception device and, more particularly, to a system and method for providing worldwide seamless location data to a wireless reception device that cannot otherwise access a satellite navigation system, such as the Global Positioning System (GPS).

2. Description of Related Art

Physical maps have traditionally been used to determine a person's location. However, with today's wireless technology, physical maps are being replaced by a satellite navigation system capable of providing location data to wireless devices. This satellite navigation system is commonly referred to as the Global Positioning System, or GPS. The GPS is formed from a constellation of twenty-four orbiting satellites and their ground stations. By using a GPS receiver, radio waves from three of the twenty-four satellites can be measured to determine an individual's location on earth. By communicating with a fourth satellite, transmission errors can be minimized to determine, within a few centimeters, an individual's exact location. The GPS, which was originally designed for military use, was dedicated to the public on Mar. 29, 1996, by a Presidential Decision Directive describing the GPS as an international information utility. According to the Directive, the U.S. will continue to operate, maintain, and provide basic GPS signals worldwide for the benefit of the public.

Many wireless devices are currently being built with GPS receivers to take advantage of such a system. By knowing one's exact location, additional information such as driving directions or area information can be obtained from a memory device or from the Internet, and one's location can automatically be provided during an emergency situation. A drawback of this system is that a wireless device containing a GPS receiver can only retrieve location data when the wireless device has an unobstructed view of at least three satellites. This becomes a problem when the wireless device is being used inside a building or in an outdoor location surrounded by tall buildings or trees. By not having continuous location coverage, an individual may be lulled into a false sense of security and find himself without location data at the precise moment it is needed.

Another problem associated with the GPS is the expense, size, and power consumption of wireless devices containing GPS receivers. Many wireless devices are only marketable if they are small enough to be carried inconspicuously, such as cellular phones. The size of a cellular phone is mainly limited by the amount of circuitry required to communicate with a local cell site. If this size is increased to house the additional circuitry and battery power necessary to obtain and process location data from a GPS satellite, then the overall size of the cellular phone may be impracticable or, at least less, marketable.

Thus, a need and a desire exists to have an inexpensive system for providing location data to a wireless reception device that cannot access a GPS signal, either because the wireless reception device is not in view of at least three orbiting satellites, or because the wireless reception device does not have a GPS receiver.

### SUMMARY OF THE INVENTION

The present invention provides a system and method for providing worldwide seamless location data to a wireless reception device that cannot otherwise access a satellite navigation system, such as the Global Positioning System (GPS). In the preferred embodiment of the present invention, a wireless location device is adapted to transmit fixed location data. The wireless location device includes a location transceiver, an antenna, and either a battery or a pair of conductive leads adapted to mate with a standard electrical outlet. The wireless location device is fixed to a structure, either by plugging the device into an electrical outlet or with the aid of mounting fixtures, and programmed with fixed location data. The location transceiver, once activated, periodically polls for a short-range wireless communication signal containing a request for location data. If a request for location data is detected, the location transceiver encodes the fixed location data within a short-range wireless communication signal. The short-range wireless communication signal is then transmitted through the antenna.

In another embodiment of the present invention, a wireless GPS/location device is adapted to transmit location data. The wireless GPS/location device includes a location transceiver, a GPS receiver, two antennas (i.e., first and second), and a power supply. The location transceiver, once activated, periodically polls the first antenna for a short-range wireless communication signal containing a request for location data. If a request for location data is detected, the GPS receiver uses satellite signals received through the second antenna to generate location data. The location transceiver then encodes the location data within a short-range wireless communication signal. The short-range wireless communication signal is then transmitted through the first antenna.

In the preferred embodiment, the short-range wireless communication signal that is received and transmitted by both devices is formatted to the Bluetooth protocol. By using the Bluetooth protocol, the short-range wireless communication signal can be retrieved by any wireless reception device containing a short-range wireless communication transceiver (i.e., Bluetooth transceiver). The transceiver will decode the short-range wireless communication signal to retrieve the embedded (fixed) location data. If the wireless GPS/location device is used in conjunction with the wireless location device, then the wireless reception device containing a short-range wireless communication transceiver can receive worldwide seamless location data.

A more complete understanding of the system and method for providing worldwide seamless location data will be afforded to those skilled in the art, as well as a realization of additional advantages and objects thereof, by a consideration of the following detailed description of the preferred embodiment. Reference will be made to the appended sheets of drawings which will first be described briefly.

### BRIEF DESCRIPTION OF THE DRAWINGS

FIG. 1 is a diagram illustrating how GPS satellites provide location data to wireless reception devices.

FIG. 2 is a posterior view of an outlet-powered wireless location device operating in accordance with one embodiment of the present invention.

FIG. 3 is an anterior view of the outlet-powered wireless location device depicted in FIG. 2.

FIG. 4 is an anterior view of a battery-powered wireless location device operating in accordance with another embodiment of the present invention.

FIG. 5 is a block diagram of the wireless location device depicted in FIGS. 3 and 4.

FIG. 6 is a diagram illustrating how a wireless location device can be used to provide a wireless reception device with location data.

FIG. 7 is a block diagram of a wireless GPS/location device operating in accordance with another embodiment of the present invention.

### DETAILED DESCRIPTION OF THE PREFERRED EMBODIMENT

The present invention provides a system and method for transmitting worldwide seamless location data to a wireless reception device that cannot otherwise interface (at least temporarily) with a satellite navigation system. In the detailed description that follows, like element numerals are used to describe like elements illustrated in one or more figures.

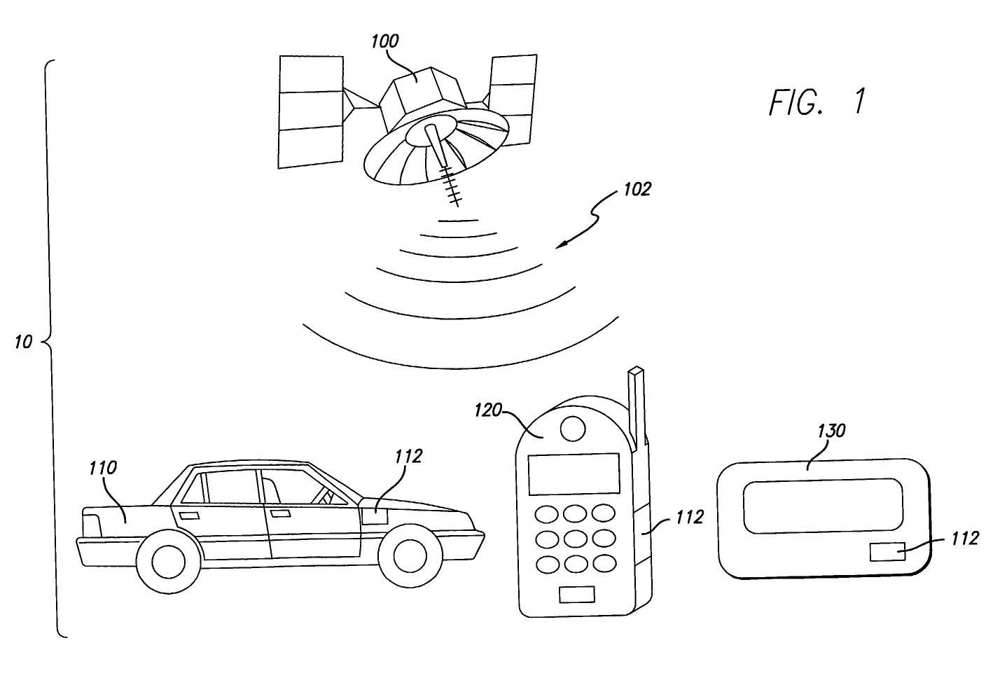

Preferred embodiments of the present invention operate in accordance with a wireless reception device and a wireless location device, where the wireless location device is adapted to provide location data to the wireless reception device. It should be appreciated that the wireless reception device may further be equipped to communicate with other wireless devices. FIG. 1 depicts a satellite navigation system 10 (e.g., GPS) commonly used to receive location data. The satellite navigation system 10 uses a plurality of satellites, which are collectively referred to as a single satellite 100, to transmit a plurality of satellite signals, collectively referred to as a single satellite signal 102. The satellite signal 102 contains a waveform coupled with a precise time message. A GPS receiver 112 receives the satellite signal 102 and uses the embedded waveform, the embedded time message, and the speed of light to calculate the location of the GPS receiver 112. The GPS receiver 112 can either be embedded within a functional device, such as an automobile 110 or a cellular telephone 120, or it can be used alone to form a navigation system 130. However, the GPS receiver 112 can only retrieve the satellite signal 102 when the GPS receiver 112 has an unobstructed view of the satellite 100. This presents a problem for GPS receivers 112 operating within a building or a densely populated urban setting, as discussed above.

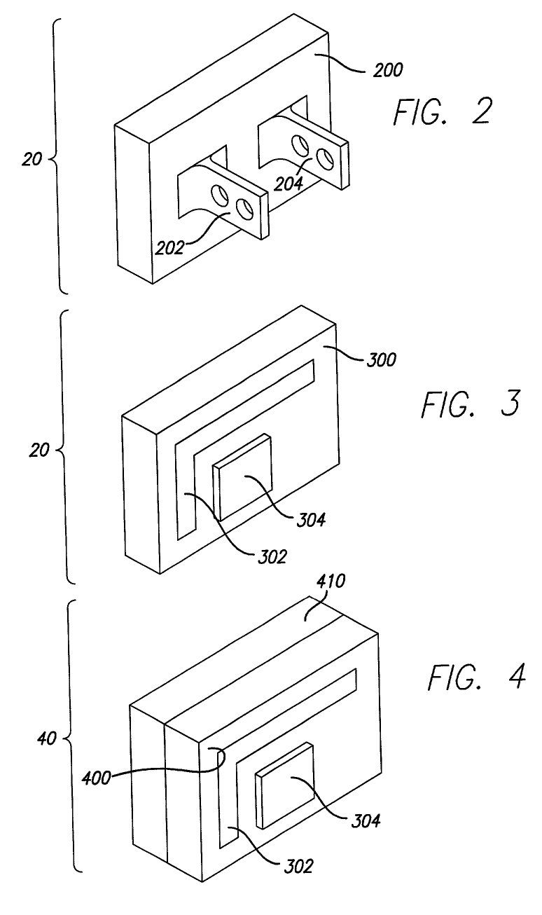

The present invention solves this problem through a wireless location device that is adapted to provide location data to a wireless reception device, specifically, when the wireless reception device cannot otherwise receive a satellite signal. FIGS. 2 and 3 depict an outlet-powered wireless location device 20 operating in accordance with one embodiment of the present invention. FIG. 2 shows the posterior surface 200 of the outlet powered wireless location device 20, which contains two conductive leads 202, 204, which are arranged to mate with a standard electrical outlet (not shown). FIG. 3 shows the anterior surface 300 of the outlet-powered wireless location device 20, which contains an antenna 302 and a location transceiver 304. It should be appreciated that the antenna 302 depicted in FIG. 3 is not intended be a limitation on the shape and/or composition of the antenna, and other wireless antennas generally known to those skilled in the art are within the spirit and scope of the present invention. It should also be appreciated that additional components (e.g., resistors, capacitors, inductors, or integrated circuits) residing on the posterior 200, anterior 300, or interior surface (not shown) of the device, is within the spirit and scope of the present invention. For example, a transformer for converting AC to DC voltage may exist separately from the location transceiver 304 on any surface (e.g., posterior 200, anterior 300) of the location device 20.

By attaching the outlet-powered wireless location device 20 to an electrical outlet, not only is the device 20 secured in a fixed location, but power from the electrical outlet can be provided to the location transceiver 304 through the two conductive leads 202, 204. The location transceiver 304 can then receive location data (if not already preprogrammed) through the antenna 302. Since the outlet-powered wireless location device 20 is fixed in one location, the location data provided comprises fixed location data pertaining to that particular fixed location. The fixed location data may include, but is not limited to, longitude, latitude, altitude and address data. The location transceiver 304 periodically polls the antenna 302 to see if any wireless reception device is requesting location data. If a signal requesting location data is detected, the location transceiver 304 transmits the fixed location data through the antenna 302.

FIG. 4 depicts a battery-powered wireless location device 40 operating in accordance with another embodiment of the present invention. FIG. 4 shows the anterior surface 400 of the battery-powered wireless location device 40, which contains an antenna 302 and a location transceiver 304. The posterior surface of the device 40 includes a battery 410, which provides power to the location transceiver 304. The device 40 can be mounted to any surface with the aid of mounting fixtures which include, but are not limited to, double back tape, screws, nails, hook and loop fasteners, etc. The battery 410 enables the wireless location device 40 to be mounted in an obscure location, such as where there is no electrical outlet available for the operation of an outlet powered wireless location device 20. Otherwise, the battery-powered wireless location device 40 operates in the same manner as the outlet-powered wireless location device 20.

Once the battery-powered wireless location device 40 is physically installed, location data can be provided to the location transceiver 304 (if not already preprogrammed). As discussed earlier, since the battery-powered wireless location device 40 is fixed in one location, the location data provided is fixed location data pertaining to that particular fixed location. The location transceiver 304 periodically polls the antenna 302 to see if any wireless reception device is requesting location data. If a signal requesting location data is detected, the location transceiver 304 transmits the fixed location data through the antenna 302.

Although any wireless transmission of the fixed location data (or the request for location data) is within the spirit and scope of the present invention, the fixed location data is perhaps most relevant to wireless reception devices located a short distance from the wireless location device 20, 40. By transmitting the fixed location data (and the request for location data) over a short distance, the transmission circuitry is simplified which, in turn, reduces cost and power consumption of the wireless location device 20, 40 and the wireless reception device.

In the preferred embodiment of the present invention, the short-range wireless transmission signal (which contains the fixed location data or the request for such data) is formatted to the Bluetooth protocol. Although it should be appreciated that other wireless protocols may be used, Bluetooth has evolved as a standard protocol for wireless devices. Bluetooth wireless transmissions operate in the 2.4 GHz Industrial-Scientific-Medical (ISM) band, and have a range between ten and one hundred meters. A Frequency Hop (FH) spread spectrum communication technique is used, which divides the frequency band into a number of hop channels. Multiple Bluetooth units operating in the same vicinity can form a piconet by communicating on the same channel. This allows a Bluetooth unit to share information with other Bluetooth units that are operating on the same piconet. The inexpensive Bluetooth transceiver enables an inconspicuous wireless device (e.g., a wireless reception device) to communicate with another closely located wireless device (e.g., a wireless location device) without significantly increasing the size or the power consumption of either device.

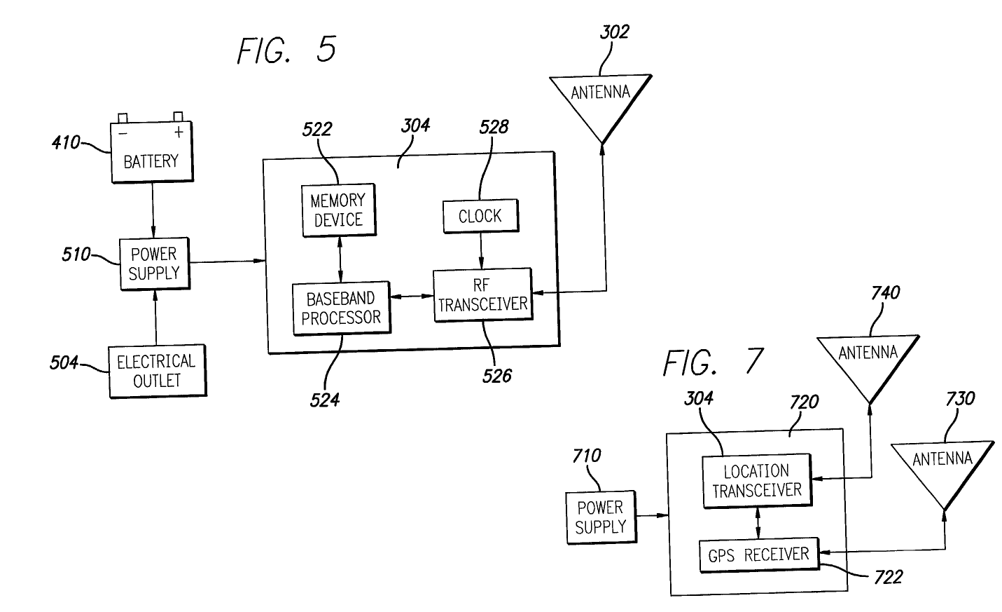

FIG. 5 is a block diagram of the two wireless location devices 20, 40 depicted in FIGS. 3 and 4, respectively. The location transceiver 304 receives and transmits data through the antenna 302, and is powered by a power supply 510, which may be a battery 410 or an electrical outlet 504. It should be appreciated that other power supplies generally known to those skilled in the art are within the spirit and scope of the present invention. The location transceiver 304 further includes an RF transceiver 526, baseband processor 524, memory device 522, and clock 528. It should be appreciated that the memory device 522 includes, but is not limited to, flash memory, EEPROM, EPROM, RAM, and all other types of memory generally known to those skilled in the art. It should also be appreciated that the components shown within the location transceiver 304 (i.e., RF transceiver 526, baseband processor 524, memory device 522, and clock 528), may be separate entities, independent from the location transceiver 304.

Once the power supply 510 is connected to the location transceiver 304, the baseband processor 524 operates in accordance with the clock 528 and an instruction code stored within the memory device 522. In a preferred embodiment of the present invention, to help achieve an accurate frequency, a crystal is used to generate the clock 528. However, it should be appreciated that other clock-generating devices generally known to those skilled in the art, such as oscillators, are within the spirit and scope of this invention. The instruction code stored within the memory device 522 may contain sleep state information (for reducing power consumption), polling information (for detecting incoming signals), or processing information (for receiving requests and transmitting fixed location data). This instruction code may further allow the baseband processor 524 to operate in one of two modes or, more particularly, a “broadcast mode” or an “on-demand mode.”

In the “broadcast mode”, the fixed location data is periodically transmitted regardless of any request for such data. At certain predetermined time-intervals, the baseband processor 524 retrieves fixed location data from the memory device 522. This fixed location data is then modulated into a baseband signal and provided to the RF transceiver 526. The RF transceiver 526 filters, amplifies, and mixes the baseband signal up to a high frequency signal (e.g., 2.4 GHz for Bluetooth) so that it can be transmitted to a wireless reception device via the antenna 302.

In the “on-demand mode”, the fixed location data is only transmitted when requests for such data are receiving. At certain predetermined time-intervals, the RF transceiver 526 is instructed (by the baseband processor 524) to poll the antenna 302 for incoming signals. If an incoming signal is detected within the antenna 302, then the RF transceiver 526 amplifies, filters, and mixes the high frequency incoming signal (e.g., 2.4 GHz for Bluetooth) down to a baseband signal, and provides it to the baseband processor 524. The baseband processor 524 then demodulates the baseband signal and authenticates it as a request for fixed location data. Upon authentication, fixed location data is retrieved from the memory device 522 and transmitted as described in the “broadcast mode” above. In describing both of these modes, it has been assumed that fixed location data already resides within the memory device 522. If that is not the case, or new fixed location data is to be stored within the memory device 522, then a request-to-store signal can be sent to the location transceiver 304 in the same manner as any other incoming signal. The baseband processor will authenticate (i.e., recognize) the incoming signal as a request-to-store signal, and store the accompanying fixed location data in the memory device 522 for future use.

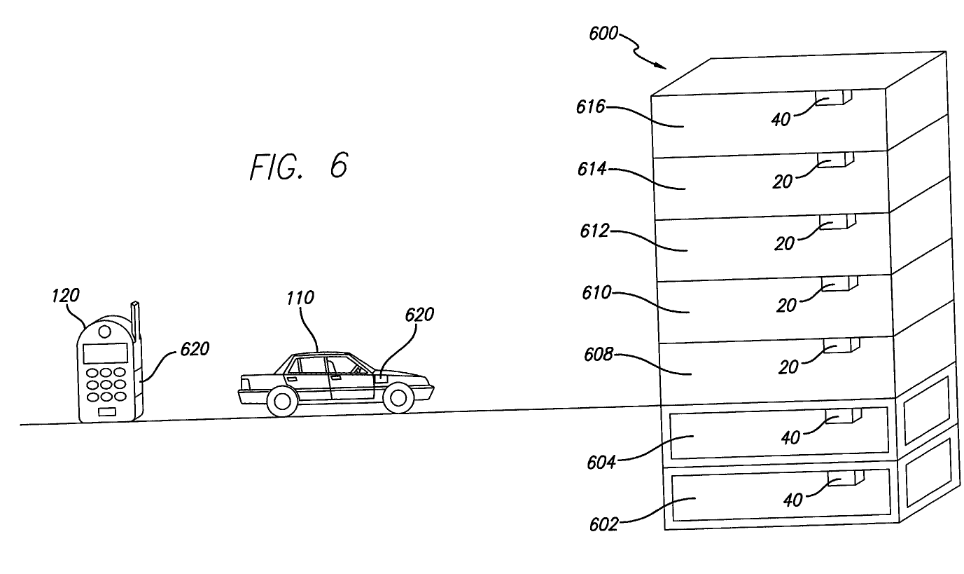

FIG. 6 depicts how a wireless location device can provide location data to a wireless reception device that cannot otherwise access a satellite navigation system (e.g., GPS). Referring back to FIG. 1, functional devices, such as an automobile 110 or a cellular telephone 120, may further include a GPS receiver 112 for communicating with a satellite 100. However, a satellite signal 102 can only be received when the GPS receiver 112 has an unobstructed view of the satellite 100. Thus, when the automobile 110 or the cellular telephone 120 enters a building, no satellite signal 102 can be received. FIG. 6 depicts a building 600 containing five office levels (i.e., 608, 610, 612, 614, 616) and two parking levels (i.e., 602, 604), where each level contains a wireless location device 20, 40. When the automobile 110 is parked on the first parking level 604, or the cellular telephone 120 is located on the third office level 612, neither device 110, 120 will be able to receive a satellite signal (i.e., satellite location data). However, if either device 110,120 contains a short-range wireless communication transceiver 620 (e.g., Bluetooth transceiver), then they will be able to retrieve location data from the wireless location devices 20, 40. It should be appreciated that the wireless devices depicted in FIG. 6 are not intended to limit the number and/or location of wireless location devices operating in accordance with the present invention. It should be appreciated that multiple wireless location devices operating on a single floor would be within the spirit and scope of the present invention.

The wireless location devices 20, 40 contain fixed location data, as previously described. Each device 20, 40 periodically listens for a request for location data from a short-range wireless communication transceiver 620, which is typically located within a wireless reception device (e.g., 110, 120). If a request is received, fixed location data is provided to the short-range wireless communication transceiver 620. If a short-range wireless communication transceiver 620 is located within the broadcasting range (e.g., ten to one hundred meters for Bluetooth) of more than one wireless location device 20, 40, then a plurality of location data may be received. However, the wireless reception device 110, 120 (which houses the short-range wireless communication transceiver 620) can use known techniques to determine which location data has stronger signal strength, and should be considered the more accurate location data.

Assuming the wireless location devices 20, 40 depicted in FIG. 6 do not have overlapping broadcasting ranges, then the cellular device 120 located on the third office level 612 will receive location data from the corresponding wireless location device 20, where the location data may indicate that the cellular device 120 is located in the building 600, on the third office level 612, or it may indicate the appropriate longitude, latitude and altitude of the third office level 612. The automobile 110, which is located on the first parking level 604, will receive location data from the corresponding wireless location device 40, where the location data may indicate that the automobile 110 is located in the building 600, on the first parking level 604, or it may indicate the appropriate longitude, latitude, and altitude of the first parking level 604.

In another embodiment of the present invention, a GPS receiver may be used in conjunction with a location transceiver to provide location data to a wireless reception device. As previously mentioned, GPS receivers 112 are not only bulky and consume a lot of power, but they also cannot receive location data within a building, tunnel, or crowded urban setting. Alternatively, a wireless device containing only a short-range wireless communication transceiver 620 (as described above) cannot typically receive location data outside of an urban setting (due to the lack of wireless location devices 20, 40 outside of urban settings). The solution to such a problem is shown in FIG. 7, where a wireless GPS/location device 720 is used to provide a wireless reception device containing a short-range wireless communication transceiver 620 (see FIG. 6) with location data.

The wireless GPS/location device 720 contains a location transceiver 304 and a GPS receiver 722, where signals are received and transmitted through a pair of antennas 740, 730 (i.e., first and second), and power is provided through a power supply 710. It should be appreciated that the depiction of the antennas 740, 730 in FIG. 7 is not intended to further limit the antennas (e.g., as to shape, size, number, or connectivity). For example, these antennas 740, 730 may exist solely as a single antenna (not shown) connected to the location transceiver 304 and/or the GPS receiver 722. The GPS receiver 722 receives satellite signals through the second antenna 730, and uses the received satellite signals to generate location data. The location transceiver 304 (which operates as previously discussed) then encodes the location data within a short-range wireless signal, preferably adhering to the Bluetooth protocol. The short-range wireless signal is then sent through the first antenna 740. By using the wireless GPS/location device 720, the bulky and power consuming GPS receiver 722 can be used within an automobile, or on the outside of a building, where bulk and power are not an issue. The short-range wireless communication signal emanating from such a device 720 can provide location data to a lightweight, lower power, wireless reception device that has a short-range wireless communication transceiver 620 (see FIG. 6).

Referring back to FIG. 6, assume, for this example only, that the cellular telephone 120 contains a short-range wireless communication transceiver 620, and the automobile 110 contains a wireless GPS/location device 720. Then, if an individual carrying their cellular telephone 120 is on the fourth office level 614, their cellular telephone 120 will receive location data from the corresponding wireless location device 20. When the individual goes downstairs and gets into a car, which is located on the second parking level 602, their cellular telephone 120 will again receive location data from the corresponding wireless location device 40. However, when the individual drives outside the building 600, the cellular telephone 120 will receive location data from the wireless GPS/location device 720, where the location data was generated from GPS satellite signals. Thus, the mobile automobile 110, which contains the wireless GPS/location device 720, works together with the stationary building 600, which contains wireless location devices 20, 40, to provide a worldwide seamless network of piconets. The piconets enable a lightweight, low power, cellular telephone 120 to use a short-range wireless communication transceiver 620 to retrieve location data.

Having thus described a preferred embodiment of a system and method for providing worldwide seamless location data to a wireless reception device, it should be apparent to those skilled in the art that certain advantages of the system have been achieved. It should also be appreciated that various modifications, adaptations, and alternative embodiments thereof may be made within the scope and spirit of the present invention. The invention is further defined by the following claims.

What is claimed is:

1. A wireless location device adapted to be affixed in a single immobile location, said wireless location device comprising:
an antenna;
a memory device containing fixed location data, said fixed location data identifying said single immobile location; and
a location transceiver connected to said antenna and said memory device, said location transceiver being adapted to transmit said fixed location data via a short-range wireless communication signal.

2. The wireless location device according to claim 1, further comprising a battery, wherein said battery provides power to said location transceiver.

3. The wireless location device according to claim 1, further comprising a power plug adapted for connection to a power source, wherein said power source provides power to said location transceiver.

4. The wireless location device according to claim 3, where in said power source further comprises an electrical outlet.

5. The wireless location device according to claim 3, wherein said power source further comprises a battery.

6. The wireless location device according to claim 1, further comprising copper traces disposed on a circuit board, wherein said antenna further comprises a portion of said copper traces.

7. The wireless location device according to claim 1, wherein said fixed location data further comprises latitude, longitude and altitude data.

8. The wireless location device according to claim 1, wherein said fixed location data further comprises address data.

9. The wireless location device according to claim 1, wherein said single immobile location is selected from a list of locations consisting of an above-ground structure location, a below-ground structure location, and a mobile structure location.

10. The wireless location device according to claim 1, wherein said short-range wireless communication signal is formatted to comply with Bluetooth protocol.

11. The wireless location device according to claim 1, wherein said short-range wireless communication signal has a maximum transmission length of approximately one-hundred meters.

12. A method for communicating location data to a wireless reception device, comprising the steps of:
attaching a wireless location device to a single immobile location;
storing fixed location data in said wireless location device, wherein said fixed location data identifies said single immobile location;
receiving a request-for-location-data signal from a wireless reception device;
generating a short-range wireless communication signal containing said fixed location data; and
transmitting said short-range wireless communication signal.

13. The method of claim 12, wherein the step of attaching said wireless location device to a single immobile location further comprises plugging said wireless location device into an electrical outlet.

14. The method of claim 12, wherein the step of storing said fixed location data further comprises storing address data in said wireless location device.

15. The method of claim 12, wherein the step of storing said fixed location data further comprises storing latitude, longitude and altitude data in said wireless location device.

16. The method of claim 12, wherein the step of generating said short-range wireless communication signal further comprises formatting said short-range wireless communication signal to comply with Bluetooth protocol.

17. A method for communicating location data to at least one wireless device, comprising the steps of:
retrieving satellite data from at least one orbiting satellite;
generating location data from said satellite data;
encoding said location data in a short-range wireless communication signal; and
transmitting said short-range wireless communication signal.

18. The method of claim 17, wherein the step of retrieving satellite data further comprises retrieving satellite data from at least three orbiting satellites.

19. The method of claim 17, wherein the step of generating said short-range wireless communication signal further comprises formatting said short-range wireless communication signal to comply with Bluetooth protocol.

20. The method of claim 17, wherein said short-range wireless communication signal further comprises a maximum transmission length of approximately one-hundred meters.

21. The method of claim 17, wherein said short-range wireless communication signal further comprises a maximum transmission length of approximately ten meters.

22. A wireless location device comprising:
a first antenna;
a second antenna;
a GPS receiver adapted to receive satellite data from at least one orbiting satellite via said second antenna, said GPS receiver further being adapted to generate location data from said satellite data; and
a location transceiver adapted to encode said location data in a short-range wireless communication signal, said location transceiver further being adapted to transmit said short-range wireless communication signal through said first antenna.

23. The wireless location device according to claim 22, wherein said GPS receiver is further adapted to receive satellite data from at least three orbiting satellites.

24. The wireless location device according to claim 22, further comprising copper traces disposed on a circuit board, wherein said first antenna further comprises a portion of said copper traces.

25. The wireless location device according to claim 22, wherein said location data further comprises latitude, longitude and altitude data.

26. The wireless location device according to claim 22, wherein said location data further comprises address data.

27. The wireless location device according to claim 22, wherein said short-range wireless communication signal is formatted to comply with Bluetooth protocol.

28. The wireless location device according to claim 22, wherein said short-range wireless communication signal has a maximum transmission length of approximately one-hundred meters.
